(19) United States
(12) Patent Application Publication
(10) Pub. No.: US 2026/0366576 A1
(43) Pub. Date: Nov. 19, 2026

(54) ELASTIC JAW COUPLING

(71) Applicant: Centa-Antriebe Kirschey GmbH, Haan (DE)

(72) Inventors: Mahamudul Hasan, Bochum (DE); Martin Fitsch, Wuppertal (DE)

(21) Appl. No.: 19/470,605

(22) PCT Filed: Mar. 19, 2024
(86) PCT No.: PCT/EP2024/057330

§ 371 Date: Sep. 29, 2025

(30) Foreign Application Priority Data
Mar. 30, 2023 (DE) 10 2023 001 254.8

(51) Int. Cl. F16D 3/58

(52) U.S. Cl. CPC F16D 3/58

(57) ABSTRACT

A jaw coupling including an inner ring element and an outer ring element, between which a middle ring element is arranged. The inner ring element and the adjacent middle ring element form an inner annular gap, and the middle ring element and the adjacent outer ring element form an outer annular gap. Bearing pockets are formed on the ring elements forming pairs of bearing spaces, in which deformable pressure bodies are arranged, and wherein bearing pocket bases extend in the bearing pockets, against which the elastically deformable pressure bodies rest and are force-coupled therewith in such a way that the torque M_{X} is transmitted. The pressure bodies are roller elements, and a bearing pocket base section points in the radial direction R_{R} to the respective annular gap and merges into a ramp base section in the circumferential direction R_{U} and in the radial direction.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

The present disclosure relates to an elastic jaw coupling and in particular to a jaw coupling rotatable about an axis of rotation A_{X} for transmitting a torque M_{X}, acting about that axis of rotation A_{X}, from a drive means to an output means. The jaw coupling has a first clutch element comprising an inner ring element in particular extending concentrically with the axis of rotation A_{X} along a first circumference U₁, and a second clutch element, rotatably mounted relative to the first clutch element, likewise comprising an outer ring element in particular extending concentrically with the axis of rotation A_{X} along an outer circumference U₂. The first clutch element is connected or connectable to the output means, and the second clutch element is connected or connectable to the drive means, or vice versa, respectively. Herein, the designation of first and second clutch element is only for ease of understanding, rather than defining which clutch element is associated or can be associated, respectively, with which means.

### BACKGROUND

Pressure bodies are force-coupled between the inner ring element and the outer ring element in such a way that torque can be transmitted via said pressure bodies between the inner ring element and the outer ring element.

Such jaw couplings are known from the prior art. In this respect, the respective ring elements usually have one or more jaws, between which the pressure elements are usually force-coupled free of play. Different jaw arrangements, jaw formations as well as geometries and arrangements of the pressure bodies are conceivable. In particular, jaws are usually designed to be isolated and are arranged substantially in a ring shape on the clutch element.

However, with the jaw couplings known from the prior art, the very high susceptibility to wear has proven to be disadvantageous, in particular when it is necessary to offer jaw couplings with a very smooth response. Also, there is the problem of making couplings available which have very good resonance damping or, respectively, are intended to compensate for resonances between the output and drive means to a maximum extent. It is also relevant that most known couplings do not succeed in generating an increasing course of the stiffness of the coupling as a function of the rotational speed of the drive means. In particular, no satisfactory solution is known for making a smooth response available at low rotational speeds, which then increases more or less linearly as the rotational speed rises.

### SUMMARY

Consequently, it is an object of the present disclosure to make a jaw coupling available which, with a simple construction, permits a force coupling between a drive means and an output means which is permanent and corresponds to the above requirements.

This object is achieved by a jaw coupling according to the independent claim.

In particular, this object is achieved by a jaw coupling rotatable about an axis of rotation A_{X} for transmitting a torque M_{X}, acting about the axis of rotation A_{X}, from a drive means to an output means, having a first clutch element comprising an inner ring element in particular extending concentrically with the axis of rotation A_{X} along a first circumference U₁, and a second clutch element, rotatably mounted relative to the first clutch element, comprising an outer ring element in particular extending concentrically with the axis of rotation A_{X} along an outer circumference U₂, wherein the first clutch element is connected or connectable to the output means, and the second clutch element is connected or connectable to the drive means, or vice versa, wherein the inner ring element and the outer ring element are arranged so as to point to one another in such a way that they form a common annular space between one another, wherein at least one middle ring element is arranged in that common annular space so as to be rotatably mounted relative to the inner ring element and to the outer ring element in the circumferential direction R_{U}, wherein the inner ring element and the adjacent middle ring element form an inner annular gap, and the middle ring element and the adjacent outer ring element form an outer annular gap, wherein bearing pockets are formed on the ring elements, with the pocket openings thereof pointing into the respective annular gap, wherein radially inwardly pointing outer bearing pockets are formed on the outer ring element, radially outwardly pointing outer bearing pockets and radially inwardly pointing inner bearing pockets are formed on the middle ring element, and radially outwardly pointing inner bearing pockets are formed on the inner ring element, wherein inwardly and outwardly pointing outer bearing pockets pointing to one another form outer bearing spaces, and inwardly and outwardly pointing inner bearing pockets pointing to one another form inner bearing spaces, wherein elastically deformable outer pressure bodies are arranged in the outer bearing spaces, and elastically deformable inner pressure bodies are arranged in the inner bearing spaces, and wherein bearing pocket bases extend in the bearing pockets, against which the elastically deformable pressure bodies rest and are force-coupled therewith in such a way that the torque M_{X} can be transmitted via said pressure bodies between the outer ring element and the inner ring element with the middle ring element interposed, wherein the pressure bodies are designed as roller elements, in particular rolls, with a diameter Ø_{D}, each rotatable about their rolling axis, coaxial with the axis of rotation A_{X}, along the bearing pocket bases, and wherein a plurality of bearing pocket bases have a bearing pocket base section which points in the radial direction R_{R} to the respective annular gap and which merges into a ramp base section trailing or leading in the circumferential direction R_{U} and likewise pointing in the radial direction R_{R} to the respective annular gap, the geometry of which ramp base section, in particular when viewed in a couplings cross-sectional plane perpendicular to the axis of rotation A_{X}, differs from the geometry of the bearing pocket base section.

It should be mentioned that the designations “outwardly” or “inwardly pointing,” respectively, “outer” or “inner,” respectively, and similar indications originate from a reference point on the axis of rotation A_{X} of the coupling. That is, for example, “point outwardly” means “pointing outwardly when viewed from the axis of rotation A_{X}.”

A substantial aspect of the disclosure is therefore the freely mounted and, in particular, rotatably mounted arrangement of the middle ring element between the outer and inner ring elements, in particular in combination with the bearing pocket bases provided with ramp base sections. Of course, a plurality of such middle ring elements can also be arranged here, in which case, in addition to the inner and outer annular gaps, further inner and outer annular gaps will then virtually result with respect to the adjacent middle ring elements. The arrangement with such a plural number of middle ring elements is also encompassed by the scope of the disclosure.

The force coupling of the pressure bodies on the adjacent ring elements and arranged in the annular gaps formed by those ring elements causes a torque transmission from the inner or outer ring element, respectively, assigned to the drive means via the middle ring element to the outer or inner ring element, respectively, assigned to the output means.

Optionally, the intermediate pressure bodies are deformed during the transmission of the torque between the adjacent ring elements.

Optionally, the annular gaps and, in particular, adjacent annular gaps are designed as rings concentric with the axis of rotation A_{X}. Those rings do not necessarily have to correspond to an ideal circular shape, but they may have recesses, protrusions or similar geometrical peculiarities. Optionally, the previously mentioned circumferences U₁ and U₂ or circumferences of further ring elements provided, respectively, in particular middle ring elements, are of different sizes. In a particular embodiment, the circumferences are so large that they allow all the ring elements to be arranged concentrically with one another, with their centers respectively located on the axis of rotation A_{X}. The circumferences may have circumferential regions with a width extending in the radial direction, in which the ring elements are arranged.

The ring elements may be integral about the entire circumference, but they may also consist of several individual components. It is conceivable that one ring element and in particular all of the ring elements have wall surfaces pointing in the radial direction, wherein opposing wall surfaces of two adjacent ring elements each delimit one annular gap or delimit partial regions of such an annular gap, respectively. Such a definition also comprises wall surfaces which do not extend completely orthogonally to the radial direction of the jaw coupling or of the respective clutch element, respectively, but also those inclined in relation thereto. Optionally, the ring elements extend in a plane extending coaxially with the axis of rotation. The ring elements or their wall elements, respectively, are optionally arranged orthogonally to a plane extending perpendicularly to the axis of rotation A_{X}. Bearing pocket bases of opposing ring elements, against each of which at least one pressure body rests, are optionally formed coaxially along the axis of rotation A_{X}. Along the circumferential direction R_{U}, it is conceivable that the wall elements extend relatively moving towards and away from one another or even extend with parallel surfaces relative to one another.

As described, the pressure bodies are designed as roller elements each rotatable about their rolling axis, coaxially with the axis of rotation A_{X}. Optionally, the pressure bodies are arranged in the circumferential direction R_{U} in the respective annular gap and optionally in a rollable manner along the bearing pocket bases.

A rotation or rolling movement, respectively, is given, for example, if two adjacent ring elements move relative to one another in the circumferential direction, for example one ring element moves towards the acting torque, while the other adjacent ring element is not yet moved or is moved to a lesser extent, wherein the intermediate pressure body is moved along by the movement of the one ring element. In this respect, the pressure body optionally rolls along the bearing pocket base of at least one ring element and optionally along the bearing pocket bases of both adjacent ring elements.

A rolling movement may optionally be completed without any, but also with, deformation of the pressure bodies. It is conceivable that, during a rolling movement, the pressure body initially does not deform or deforms only slightly and then increasingly, whereby the deformation force and, thereby, also the pressing between the two adjacent ring elements increases.

Optionally, a bearing space runs coaxially with the axis of rotation and optionally in such a way that it defines a bearing volume which runs along that coaxial axis. The pressure body is optionally introduced into that bearing space and optionally likewise has a main running axis which runs coaxially with the axis of rotation. In particular, this is conceivable when designing the pressure bodies as rolling elements. A rolling movement of the pressure body optionally takes place about an axis coaxial with the axis of rotation.

Optionally, at least two bearing pocket bases pointing to one another, with each of those bearing pocket bases arranged on one of the adjacent ring elements, enclose at least one pressure body arranged between them in the annular gap, at least in sections in a ring-shaped or similar circumferential manner. In particular, they optionally enclose the pressure body in such a way that any deformation-free radial movement of the pressure body is prevented. The same is optionally also conceivable for a deformation-free movement in the circumferential direction.

To prevent any movement of the pressure bodies in the axial direction, that is, coaxially with the axis of rotation, it is conceivable to arrange end-face bearings on the jaw coupling which prevent the pressure bodies from axially sliding out of the bearing spaces or the bearing pockets, respectively, in the direction of the axis of rotation. Such end-face bearings may optionally be arranged on the middle ring element. To complement this or as an alternative, however, it is also conceivable to attach such end-face bearings to the outer and/or inner ring elements. Such end-face bearings may be, for example, bearing plates, against which the pressure bodies rest, in particular in the deformed state. The bearing pockets may be formed in such a way that, in case of an in particular radial deformation of the pressure bodies as a result of a torque load acting on the coupling, in addition to this radial deformation as a result of the force coupling with the bearing pocket bases, this also causes an axial deformation and in particular a change in length, in particular an increase in length, of the pressure bodies along their axial main axis. If end-face bearings are provided, the pressure bodies optionally rest against those end-face bearings in that state. Also, they can have bearing elements for reducing friction with respect to the pressure bodies and in particular their end faces, which optionally rest against the end-face bearings. Such end-face bearings may have, for example, plates, plate rings, resting surfaces, etc.

It is conceivable that at least two bearing pocket bases pointing to one another, with each of those bearing pocket bases arranged on one of the adjacent ring elements, are oriented with respect to the circumferential direction R_{U} of the jaw coupling in such a way that, during a load movement B_{L} of one of the ring elements as a result of the acting torque M_{X}, the relative distance a of at least partial sections of the bearing pocket bases pointing to one another measured in the radial direction R_{R} is optionally reduced at locations where the pressure body rests. In case of a load movement B_{L}, at least partial sections of the opposing bearing pocket bases optionally move towards one another. A pressure body arranged in the bearing space or between the bearing pocket bases pointing to one another, respectively, may be compressed in this way. Optionally, the bearing pocket bases are formed and, in particular, shaped in such a way that at least partial regions of opposing bearing pocket bases not only move towards one another, but also move relative to one another in the circumferential direction. In such an arrangement, a pressure body arranged therebetween is optionally subjected to a shear load. Such a shear load may transmit torque from one ring element to an adjacent ring element. Thus, a relationship may be established between occurring radial compressions and shear compressions. It is conceivable to form the bearing pocket bases in such a way that, with increasing radial compression of the pressure bodies, an increasingly greater shear force may be transmitted in the circumferential direction.

Optionally, the bearing pocket bases are designed as bearings for the pressure bodies in such a way that, upon application of the torque M_{X}, a circumferential force component F_{U}, optionally a shear force component, acts in the direction R_{M} of the torque, and a radial force component F_{R} acts in the radial direction R_{R} on the pressure bodies resting against them. In particular in this regard, the bearing pocket bases optionally have wall elements which are inclined in relation to the circumferential direction and in relation to the radial direction so as to effect both a circumferential force component and a radial force component on the respective pressure body during a movement of the ring elements relative to one another. The orientation of the bearing pocket bases with respect to the circumferential direction and the radial direction may be designed in a variable manner. By means of such a variable configuration, for example, the increase and decrease of the circumferential force component and/or of the radial force component may be controlled.

Optionally, at least two bearing pocket bases pointing to one another, with each of those bearing pocket bases arranged on one of the adjacent ring elements, are oriented with respect to the circumferential direction of the jaw coupling in such a way that, during a load movement B_{L} of one of the ring elements towards the acting torque M_{X} (and in particular effected by the torque M_{X}), the adjacent ring element is moved in the same direction, optionally with a time offset, with deformation of the pressure body mounted between the bearing pocket bases.

To enable compression of the pressure bodies as a function of the relative movement of the adjacent ring elements, for example, a width of at least one annular gap extending in the radial direction, when viewed over its circumference, is formed to be intermittently smaller and larger. In other words, this means that the width may change over the circumference of the annular gap. Via such a change, compression of a pressure element arranged therebetween may then be achieved upon relative movement, in particular if it occurs in the circumferential direction, between adjacent ring elements and, in particular, bearing pocket bases of those ring elements.

The bearing pockets optionally form a bearing shell for receiving a partial region of the pressure body. Different geometries of those bearing pockets are conceivable, as will be described in detail in the following.

It is conceivable that bearing spaces for receiving at least one pressure body are formed by two bearing pockets opposing one another, each of those bearing pockets arranged on one of the adjacent ring elements, wherein at least one pressure body is received or receivable both in the bearing pocket of the one ring element and in the bearing pocket of the adjacent ring element. The bearing pockets optionally complement one another in such a way that they fix the pressure body in a stationary manner, in particular in an unloaded state of the jaw coupling.

As already mentioned previously, it is conceivable that the pressure bodies are rollable in those bearing pockets, in particular in the circumferential direction, and in particular upon relative movement occurring between two opposing bearing pockets. Such a rolling movement may optionally take place with simultaneous deformation of the pressure body.

It is conceivable that two bearing pockets opposing one another, each of those bearing pockets arranged on one of the adjacent ring elements, are oriented with respect to one another in the circumferential direction R_{U} and, when the torque M_{X} is not applied, in such a way that their lowest pocket points P_{T} are located on a common radial axis A_{R}. Optionally, two bearing pockets opposing one another define a maximally large bearing space for a pressure body when no torque M_{X} is applied to the jaw coupling. It is conceivable to design bearing pockets in such a way that the bearing space formed by the bearing pockets is reduced as soon as a torque M_{X} is applied and, in particular, as soon as at least one ring element is moved in the circumferential direction relative to the other ring element by means of the applied torque. It is conceivable to carry out a reduction of the bearing space and in particular of the volume of the bearing space in such a way that the pressure body mounted therein is thereby compressed.

It is conceivable that a depth T of at least one bearing pocket extending in the radial direction R_{R} changes, optionally changes continuously, and further optionally increases and then decreases, in the circumferential direction R_{U} of the ring element on which the bearing pocket is formed. A linear change is conceivable in sections, but changes may also be carried out with a changing slope. In particular, the change in the depth may be exponential, parabolic, of the geometry of a clothoid. It is conceivable that bearing pockets which correspondingly reduce in depth increase the compression of the pressure body mounted therein. It is conceivable to design the reduction in depth in such a way that, as a function of a load movement about the axis of rotation of the ring element, the compression of the pressure body rises linearly, but it is also conceivable to design the change in depth in such a way that this results in a rise in the compression deviating therefrom, for example an exponential compression. It is conceivable to arrange bearing pockets in such a way that, with a low load movement, in particular when low torques are applied, a much lower compression takes place than with a larger load movement, e.g., as a result of an increasing torque. This ensures, among other things, that a very smooth response of the jaw coupling is given during initial deflections of the ring element. As the deflection increases, the coupling then becomes harder.

It is conceivable that during a relative movement of the ring elements relative to one another in the circumferential direction, bearing pocket bases of the adjacent ring elements move past one another in such a way that, as a result of bearing pocket base regions which are arranged so as to be inclined in relation to the circumferential direction, their relative distance decreases, leading to compression of the pressure bodies.

The pressure body may have a cylindrical shape or a similar rotationally symmetric shape. Its axis of rotational symmetry optionally runs coaxially with the axis of rotation of the coupling. Starting from this axis of rotational symmetry, at least one radius of the pressure body optionally runs coplanar with the coupling cross-sectional plane perpendicular to the axis of rotation A_{X}.

It is conceivable that the elastically deformable inner pressure bodies arranged in the inner bearing spaces, optionally when in the non-deformed state, have a larger diameter Ø_{Di} than the elastically deformable outer pressure bodies arranged in the outer bearing spaces, and optionally have a diameter Ø_{Di} in the range of between 1.02 to 1.2 times larger, further optionally 1.05 to 1.15 times larger.

In case of a pressure body which is designed as a rotational body which deviates from a cylindrical shape and is configured with different radii around its axis of rotational symmetry, the above ratio may be determined from a comparison of the mean values of the radii of the pressure bodies.

It is conceivable that the elastically deformable inner pressure bodies arranged in the inner bearing spaces, optionally when in the non-deformed state, have a larger volume than the elastically deformable outer pressure bodies arranged in the outer bearing spaces.

It is conceivable that the materials used in the elastically deformable outer pressure bodies and the elastically deformable inner pressure bodies have a substantially equal degree of hardness.

It is conceivable that the elastically deformable outer pressure bodies and the elastically deformable inner pressure bodies are made from a same material.

It is conceivable that a plurality of the bearing pocket base sections and/or ramp base sections run in the direction of the axis of rotation A_{X} so as to be straight. It is conceivable that a plurality of the bearing spaces run in the direction of the axis of rotation A_{X} with a constant volume and/or so as to be straight.

It is conceivable that at least one bearing pocket base section and/or at least one ramp base section, when viewed in the coupling cross-sectional plane perpendicular to the axis of rotation A_{X}, run in a circular-arc shape, wherein optionally, the radius R_{L} of the bearing pocket base section is smaller than the radius R_{R} of the adjoining ramp base section.

In particular, the term circular-arc shape may be understood to mean a circular segmental arc shape, that is, an arc shape which is part of a fully circumferential circular arc. The circular segmental arc shape of the bearing base section may optionally have an angle of rotation between 50° and 120°, further optionally 60° and 110°. The circular segmental arc shape of the ramp base section may optionally have an angle of rotation less than 70°, further optionally less than 70°.

It is conceivable that the radius R_{La} of at least one bearing pocket base section of at least one outer bearing space and/or the radius R_{Li} of at least one bearing pocket base section of at least one inner bearing space is substantially equal to the radius, optionally in the non-deformed state, of the pressure body mounted therein. It is conceivable that the radius R_{Ra} of at least one ramp base section of at least one outer bearing space and/or the radius R_{Ri} of at least one ramp base section of at least one inner bearing space is larger than the radius, optionally in the non-deformed state, of the pressure body mounted therein.

It is conceivable that at least one bearing pocket base section of at least one outer bearing space and at least one bearing pocket base section of at least one inner bearing space, when viewed in the coupling cross-sectional plane perpendicular to the axis of rotation A_{X}, each run in a circular-arc shape. It is conceivable that the radius R_{La} of the bearing pocket base section of the outer bearing space is smaller than the radius R_{Li} of the bearing pocket base section of the inner bearing space, and/or at least one ramp base section of at least one outer bearing space and at least one ramp base section of at least one inner bearing space, when viewed in the coupling cross-sectional plane perpendicular to the axis of rotation A_{X}, each run in a circular-arc shape. It is conceivable that the radius R_{Ra} of the ramp base section of the outer bearing space is smaller than the radius R_{Ri} of the ramp base section of the inner bearing space.

It is conceivable that one ramp base section and one bearing pocket base section of at least one outer bearing space, in the coupling cross-sectional plane perpendicular to the axis of rotation A_{X}, each run in a circular-arc shape, wherein the radius R_{Ra} of the (in particular inwardly pointing outer) ramp base section is 1.5 to 4.0 times, optionally 2.0 to 3.5 times, larger than the radius R_{La} of the (in particular inwardly pointing outer) bearing pocket base section, and/or one ramp base section and one bearing pocket base section of at least one inner bearing space, in the coupling cross-sectional plane perpendicular to the axis of rotation A_{X}, each run in a circular-arc shape, wherein the radius R_{Ri} of the (in particular inwardly pointing inner) ramp base section is 1.0 to 3.0 times, optionally 1.5 to 2.5 times, larger than the radius R_{Li} of the (in particular inwardly pointing inner) bearing pocket base section.

It is conceivable to design the radii of the inner bearing spaces in a manner which is correspondingly complementary to the above radii and proportionally corresponding to the sizes, in particular the radii of the inner and outer pressure bodies.

It is conceivable that at least one bearing pocket base section runs so as to be concave when viewed in the coupling cross-sectional plane perpendicular to the axis of rotation A_{X} and with respect to the adjacent inner or outer annular gap.

It is conceivable that at least one bearing pocket base, when viewed in the coupling cross-sectional plane perpendicular to the axis of rotation A_{X}, is designed as a tray in which the pressure body mounted therein is guided in a stationary manner in the unloaded state of the coupling.

It is conceivable that at least one bearing pocket base, comprising a bearing pocket base section and a ramp base section, when viewed in the coupling cross-sectional plane perpendicular to the axis of rotation A_{X}, runs in an arcuate manner, wherein its running curve, with respect to a distance from the axis of rotation A_{X}, has a vertex P_{S} with a maximum distance Aₘₐₓ or a minimum distance Aₘᵢₙ from the axis of rotation A_{X}, wherein the vertex P_{S} is located in the bearing pocket base section. In particular in case of an inwardly pointing inner and/or outer bearing pocket, the vertex P_{S} may have such a maximum spacing Aₘₐₓ. In particular in case of an outwardly pointing inner and/or outer bearing pocket, the vertex P_{S} may have such a minimum spacing Aₘᵢₙ.

If it is assumed that the vertex P_{S} is located on a radial axis through the axis of rotation A_{X}, and the center point of the circular segmental arc defining the bearing base section is also located on this radial axis, then it is optionally true that the circular arc of the bearing base section running in the direction of the adjoining ramp base section runs at a partial angle of rotation of 2° to 20°, optionally 3° to 10° beyond that radial axis and the vertex P_{S}. At the end of this circular arc is the merging point P_{Ü} to the arc and in particular circular arc, in particular circular segmental arc, of the ramp arc section.

The ramp base section and the bearing pocket base section merge, optionally continuously, into one another at a merging point P_{Ü}.

It is conceivable that, when viewed in the coupling cross-sectional plane perpendicular to the axis of rotation A_{X}, ramp base sections opposing one another and forming a common bearing space are designed to be substantially, in particular exactly, of the same length. The length of the ramp base section is optionally, when viewed in the coupling cross-sectional plane perpendicular to the axis of rotation A_{X}, the length from the vertex P_{S} or the merging point P_{Ü} and the free end of the ramp base section, located at the outer or inner annular gap, respectively. In particular, all of the ramp base sections of the inner bearing spaces and/or of the outer bearing spaces may optionally be designed to be of the same length.

It is conceivable that, when viewed in the coupling cross-sectional plane perpendicular to the axis of rotation A_{X}, a segmental arc center point of a bearing pocket base section, extending in a circular-arc shape, of at least one bearing pocket base is located on a radial axis through the axis of rotation A_{X}, and a segmental arc center point of a ramp base section, extending in a circular-arc shape, of the same bearing pocket base is located on a parallel axis orthogonally offset from the radial axis by a value X.

Optionally, only one pressure body is arranged in at least a plurality, optionally in all of the bearing spaces.

In a particular embodiment, instead of the circular-arc shape of the bearing pocket section and/or the ramp base section, a similar continuous arc shape may also be provided. Within the scope of the disclosure, this is then also to be understood to mean a “circular-arc shape” or “circular arc shaped.” Optionally, the shape of the bearing pocket is formed to be complementary to the shape of the pressure body at least in sections and in particular in such a way that the latter rests against it free of play.

At least one ramp base section optionally differs from the geometry of the remaining bearing pocket or a section thereof, respectively, in particular the geometry in a region in which the pressure body is arranged if no torque is applied to the jaw coupling, that is, optionally the bearing base section. The response of the jaw coupling may optionally be determined via the geometry of a ramp base section.

Optionally, the ramp base section, pointing in the radial direction towards the annular gap, has an optionally continuous slope in sections and/or an increasing slope. In addition to a continuous (increasing) slope, the slope may also increase discontinuously. As soon as a pressure body is moved, and in particular rolled, along that ramp base section, an increase in slope means a correspondingly more and more increasing compression of the pressure body, wherein optionally, the forces transmittable in the circumferential direction increase. With the same slope, the compression increases uniformly. Such a (rolling) movement may occur in case of a relative movement of two adjacent ring elements.

Optionally, opposing ramp base sections of bearing pockets at adjacent ring elements, with respect to the torque direction R_{M}, are designed as trailing ramp base sections on the one ring element and as leading ramp base sections on the adjacent ring element. Herein, leading optionally means that they are formed in the direction of the torque at the front end of the bearing pocket. Trailing optionally means that they are formed at the rear end of the bearing pocket with respect to the torque direction. It is conceivable that ramp base sections at the ring element connected or connectable to the drive means, with respect to the torque direction R_{M}, are designed as trailing ramp base sections and optionally, opposing ramp base sections of the adjacent ring element are designed as leading ramp base sections.

Optionally, when viewed in a coupling cross-sectional plane perpendicular to the axis of rotation A_{X}, two bearing pockets define a bearing space, wherein an inwardly pointing bearing pocket has a bearing pocket base section and a following ramp base section, when viewed in a rotational direction about the axis of rotation, and an outwardly pointing bearing pocket has a bearing pocket base section and a leading ramp base section, when viewed in the same rotational direction about the axis of rotation.

It is also conceivable that bearing pocket sections, optionally ramp base sections, formed on a ring element run in the circumferential direction R_{U} in such a way that opposing in the radial direction R_{R}, no bearing pocket sections are formed on the adjacent ring element, at least in a state in which no torque M_{X} acts. It is conceivable, in particular in this regard, that opposing bearing pockets of adjacent ramp base sections run offset from one another in the circumferential direction. Bearing pockets may start at a ring element, while the opposing bearing pocket starts somewhat later or earlier.

The same applies, of course, to the ends of those bearing pockets. It is possible for all the bearing pockets of a ring element to be of identical design. It is conceivable that opposing bearing pockets of adjacent ring elements are of identical design. It is also conceivable, however, that bearing pockets of a ring element located radially further outward are designed to be somewhat larger and, in particular, longer in the circumferential direction than bearing pockets located further inward, in particular of the adjacent ring element. It is conceivable to design opposing bearing pockets of two adjacent ring elements to be identical, or smaller or larger but with the same geometry, however, rotated by 180° about an axis, optionally by 160° to 200° coaxially with the axis of rotation.

Further embodiments of the disclosure result from the dependent claims.

### BRIEF DESCRIPTION OF THE DRAWINGS

In the following, the disclosure is described with reference to exemplary embodiments which are explained in more detail by the accompanying drawings. In the schematic drawings:

FIGS. 1 and 2 show an isometric representation of an embodiment of the jaw coupling from different viewing angles;

FIGS. 3 and 4 show the representations according to FIGS. 1 and 2 without any end-face bearing (rings);

FIG. 5A shows a cross-section through the embodiment according to FIG. 1;

FIG. 5B shows a detailed representation of the representation according to FIG. 5A;

FIG. 5C shows a further detailed representation of the representation according to FIG. 5A;

FIG. 6 shows a longitudinal section through the embodiment according to FIG. 1;

FIGS. 7 through 9 show different load and deflection states of the embodiment according to FIG. 1;

FIGS. 10 through 13 show further embodiments of the disclosure with differently acting torques.

### DETAILED DESCRIPTION

In the following, the same reference numerals are used for identical and identically acting components, with superscript indices sometimes applied to distinguish between them. Position indices a and i are also used, which may be used in conjunction with a component to further define its position. It should be noted that the designation of a component with a reference numeral without any further specification of “a” or “i” does not exclude it being a correspondingly specified or specifiable component. Rather, this is encompassed, unless defined otherwise.

Unless defined otherwise, all terms used herein (including any technical and scientific terms) shall have the same meaning, and in particular a meaning as generally understood by a person of ordinary skill in the relevant art when interpreted with regard to the description and drawings. It is further to be understood that terms such as those defined in generally used dictionaries are interpreted with respect to the technical field relevant herein, and not in an idealized or overly formal sense, unless this is explicitly so defined. In certain cases, a detailed description of devices and methods universally known may be omitted to avoid redundancy of the description. The description of certain embodiments and the terminology used therein are not intended to limit the disclosure. The singular forms “a/an,” “the” may also include the plural forms, unless the context clearly suggests otherwise. The expression “and/or” includes any and all combinations of one or more of the associated items listed. It is to be understood that the phrases “comprises” and/or “comprising” indicate the presence of cited features, but do not exclude the presence or addition of one or more other features. Further, it is to be understood that, if a certain step of a method is indicated as following another step, it may follow this other step directly or one or more intermediate steps may be performed before the certain step is carried out, unless this is indicated otherwise. In the same way, it is to be understood that, if a connection between structures or components is described, this connection may be direct or via intermediate structures or components, unless it is specified otherwise. Reference is made to the disclosure of all publications, patent applications, patents and other literature mentioned herein in its entirety. In the event of any conflict, the present specification, including its definitions, shall apply.

The disclosure is described herein with reference to the accompanying drawings, in which embodiments of the disclosure are shown. However, the disclosure may also be practiced in many different forms and should not be understood as being limited to the embodiments set forth herein. Rather, the embodiments are indicated herein so that the present disclosure is detailed and complete and sets forth the scope of the disclosure to the person skilled in the art in a complete but exemplary manner. The description of the exemplary embodiments is to be read with regard to the accompanying drawings, which are to be considered as part of the entire written description. In the drawings, the absolute and relative sizes of systems, components, layers and regions may be exaggerated for reasons of clarity. Embodiments may be described with reference to schematic and/or cross-sectional illustrations, idealized embodiments and intermediate structures of the disclosure. Relative terms as well as their derivatives should be understood to refer to the orientation as described or shown there in the drawing presently discussed. Those relative terms serve the purpose of a clearer description and do not require the system to be set up or operated in a certain orientation unless explicitly indicated otherwise. Any of the disclosed devices or parts thereof may be combined together or divided into further parts, unless specifically indicated otherwise. The mere fact that certain measures are listed in different sections or claims is not intended to indicate that no combination of those measures can be advantageously made. In particular, all conceivable combinations of the claims are to be regarded as inherently disclosed. In this description, words such as “substantially”, “approximately” or “in general/generally” are intended to be interpreted as including at least deviations from a measurement of 10% or less, preferably 5% or less, or deviations from a shape which would still fall within the scope of the definition in question for a person skilled in the art, unless this is specified otherwise.

For reasons of clarity and in the sense of a stringent description, features are usually described herein as part of one or more separate embodiments; however, it is self-evident that the scope of the disclosure may also contain embodiments having combinations of all or some of the features described.

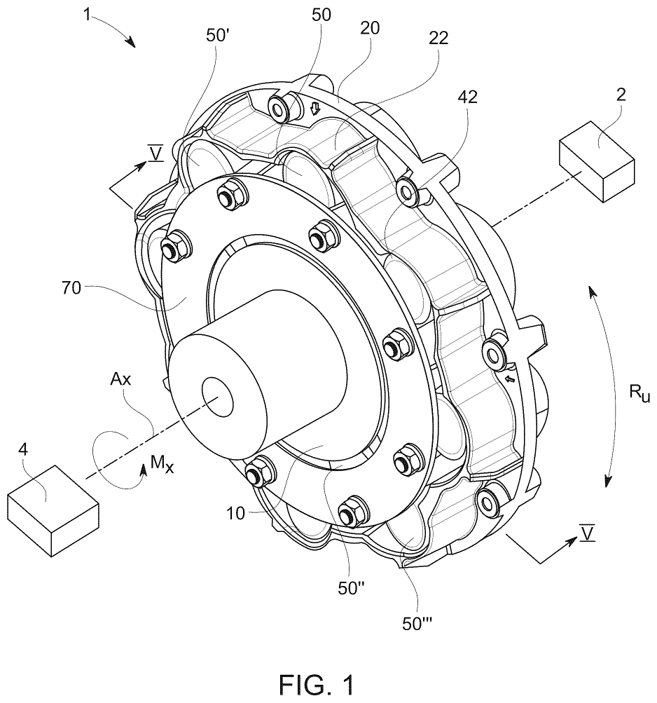

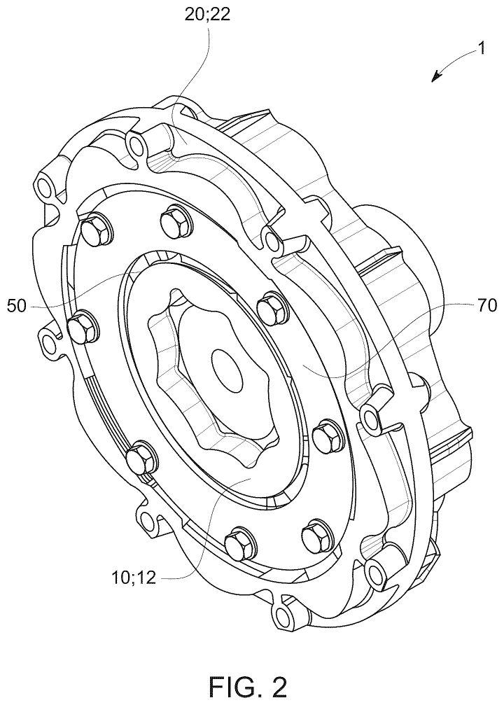

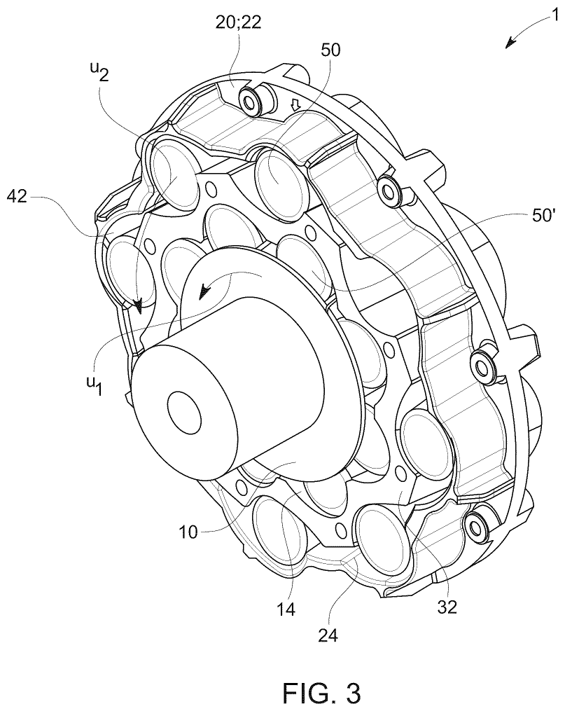

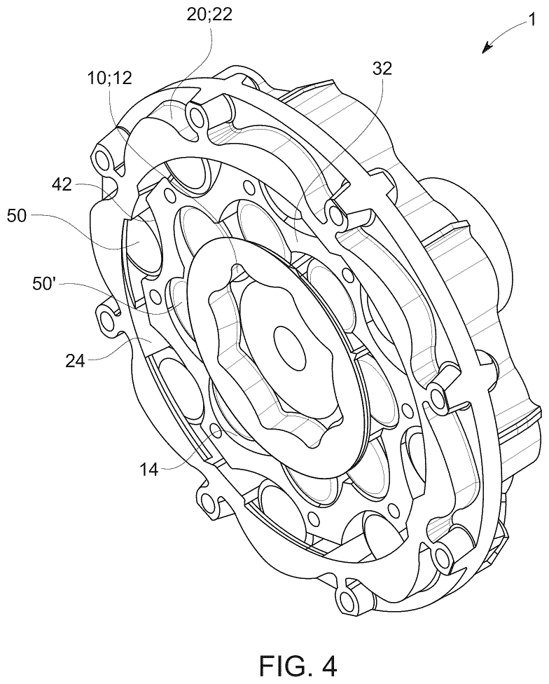

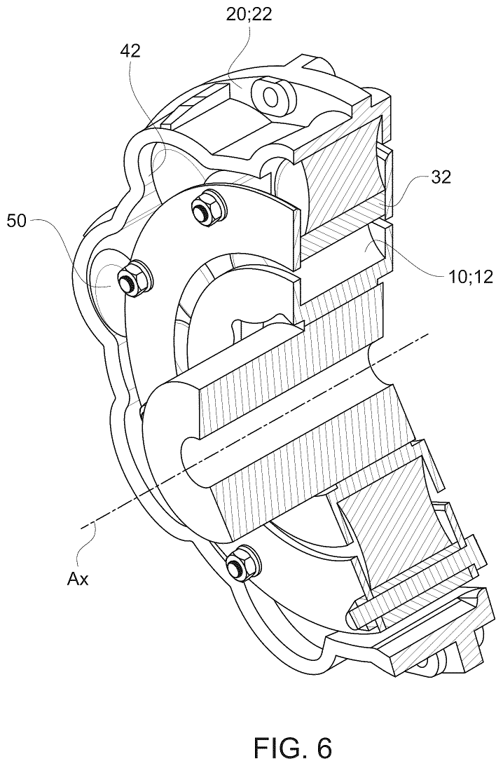

The representations according to FIGS. 1 through 6 show an embodiment of the elastic jaw coupling 1 with features as described in detail previously. All of the previously cited embodiments are optionally present in this embodiment represented herein. This applies both in combination and by themselves. In this respect, explicit reference is made to the passages described previously and those are applied to the embodiments represented herein.

The embodiment represented herein has a first clutch element 10 and a second clutch element 20. The first clutch element 10 is connected or connectable, by way of example, to an output means, for example a transmission, and the second clutch element 20 is connected or connectable, by way of example, to a drive means 2, for example a motor. The first clutch element 10 and the second clutch element 20 are arranged so as to be twistable relative to one another, wherein this twist, as will be described in detail in the following, is defined and controlled by force-coupling pressure bodies 50.

The first clutch element 10 comprises an inner ring element 12 in particular extending concentrically with the axis of rotation A_{X} along a first circumference U₁. The second clutch element 20, in contrast, comprises an outer ring element 22 in particular extending concentrically with the axis of rotation A_{X} along an outer circumference U₂. Of course, depending on the embodiment of the first and second clutch elements, the ring element of the second clutch element may be arranged as an inner ring element, and the ring element of the first clutch element may be arranged as an outer ring element. Herein, the definition of “first” and “second” serves only for explanation and does not represent any limiting, in particular defining, indication of position.

The first clutch element is rotatably mounted relative to the second clutch element and is in particular rotatably mounted along the axis of rotation A_{X} about which the torque M_{X} extends. The jaw coupling 1 has a circumference which is also defined by a radius extending through the axis of rotation A_{X}. The circumferential line of the jaw coupling may be annular, but it may of course also have recesses and protrusions or similar geometric irregularities.

The same applies to the geometries of the inner ring element and of the outer ring element.

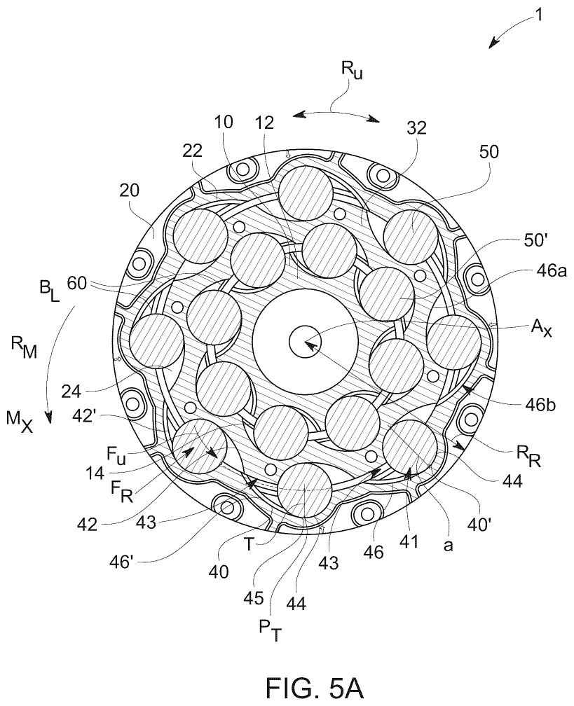

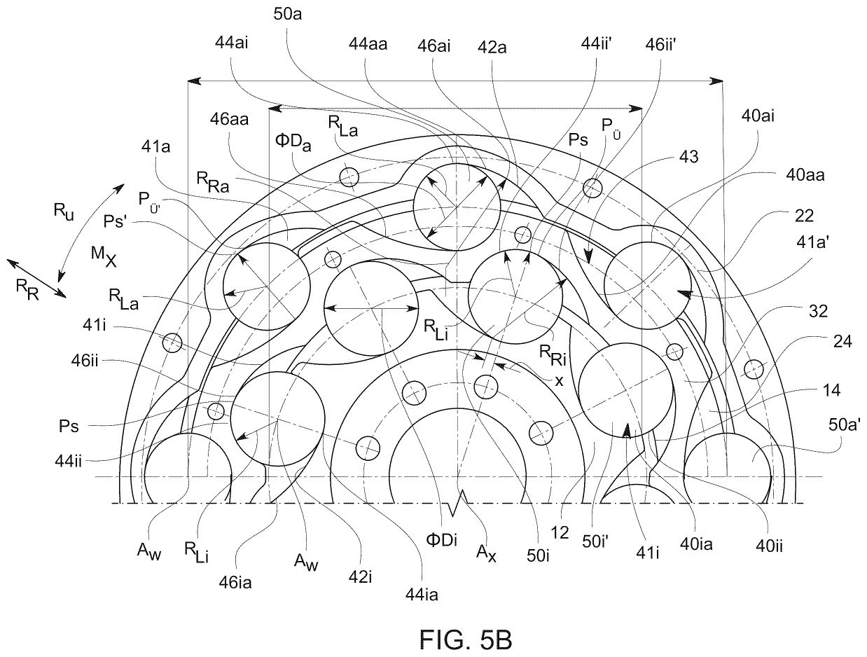

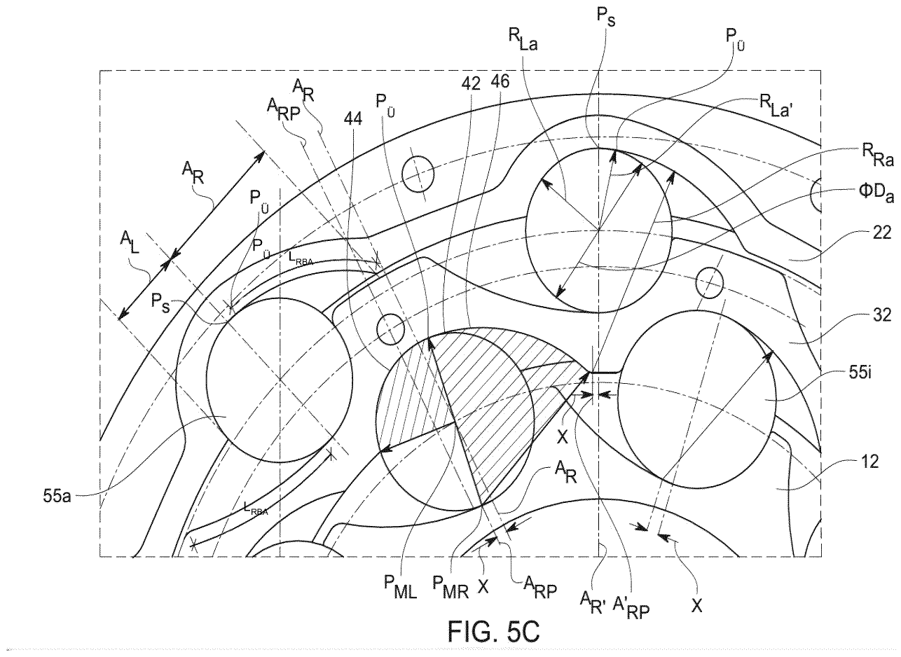

The inner ring element 12 and the outer ring element 22 are arranged so as to point to one another in such a way that they form a common annular space 60 between one another. By way of example, that annular space 60 is represented in FIGS. 5 and 5A.

A middle ring element 32 is arranged in that common annular space 60 and is rotatably mounted relative to the inner ring element 12 and the outer ring element 22. In principle, the middle ring element is optionally mounted in the common annular space 60 exclusively via pressure bodies 50, at least with respect to movements along the section plane represented in FIG. 5A.

The inner ring element 12 and the adjacent middle ring element 32 form an inner annular gap 14. The middle ring element 32 and the adjacent outer ring element 22 form an outer annular gap 24.

As shown in detail in FIG. 5B, bearing pockets 40 are formed on the ring elements 12, 22, 32, with the pocket openings 43 thereof pointing into the respective annular gap 14, 24, wherein radially inwardly pointing outer bearing pockets 40ai are formed on the outer ring element 22, radially outwardly pointing outer bearing pockets 40aa and radially inwardly pointing inner bearing pockets 40ii are formed on the middle ring element 32, and radially outwardly pointing inner bearing pockets 40ia are formed on the inner ring element 12.

Inwardly and outwardly pointing outer bearing pockets 40ai, 40aa pointing to one another form outer bearing spaces 41a, and inwardly and outwardly pointing inner bearing pockets 40ii, 40ia pointing to one another form inner bearing spaces 41i.

Elastically deformable outer pressure bodies 50a are arranged in the outer bearing spaces 41a, and elastically deformable inner pressure bodies 50i are arranged in the inner bearing spaces 41i. The pressure bodies 50 are designed as roller elements, in particular rolls, with a diameter Ø_{D}, each rotatable about their rolling axis A_{w}, coaxial with the axis of rotation A_{X}, along bearing pocket bases 42.

Those bearing pocket bases 42 are formed in the bearing pockets 40 in such a way that the elastically deformable pressure bodies 50a, 50i rest against them and are force-coupled therewith in such a way that the torque M_{X} can be transmitted via said pressure bodies between the outer ring element 22 and the inner ring element 12 with the middle ring element 32 interposed.

A plurality of bearing pocket bases 42 have a bearing pocket base section 44 which points in the radial direction R_{R} to the respective annular gap 14, 24 and which merges into a ramp base section 46 trailing or leading in the circumferential direction R_{U} and likewise pointing in the radial direction R_{R} to the respective annular gap 14, 24, the geometry of which ramp base section, in particular when viewed in a coupling cross-sectional plane perpendicular to the axis of rotation A_{X}, differs from the geometry of the bearing pocket base section 44.

To distinguish between trailing and leading, one and the same direction of revolution R_{U} is to be taken as the basis. Thus, for example, in a direction of revolution R_{U} in a clockwise direction assumed in FIG. 5B, a “leading ramp base section” 46aa is arranged to be offset in front of the associated bearing pocket base section 44aa in a counterclockwise direction, and a “trailing ramp base section” 46ai is arranged to be offset behind an associated bearing pocket base section 44ai in a clockwise direction.

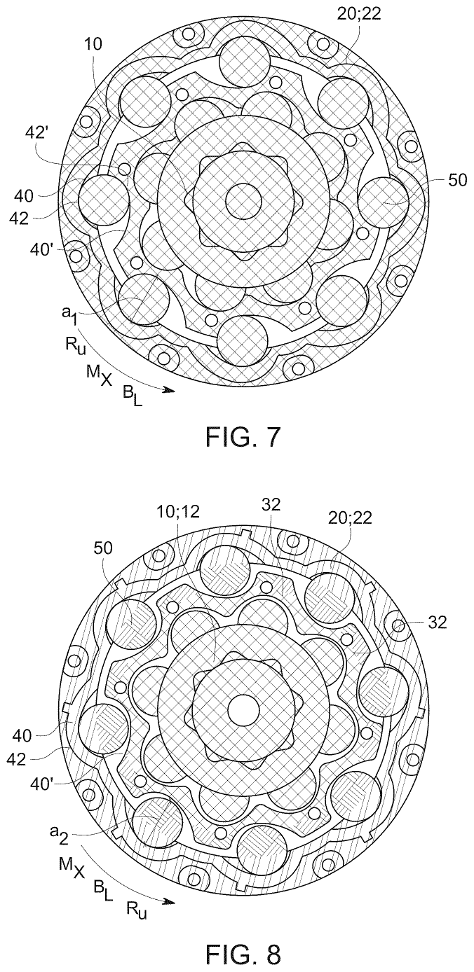

The pressure bodies 50 are designed as roller elements, each rotatable about their rolling axis A_{w} extending coaxially with the axis of rotation A_{X}. As described in detail in the following, in particular as described with respect to FIGS. 7 through 9, those pressure bodies 50 are arranged in the circumferential direction R_{U} in the respective annular gap 14, 24 and optionally in a rollable manner along the bearing pocket bases 42. As will be described in detail, that rolling movement takes place herein, by way of example, with simultaneous deformation of the pressure bodies 50 upon application of the torque M_{X} and carrying out a load movement B_{L} as represented in FIGS. 7 through 9. Bearing pocket bases 42 opposing one another, each arranged on adjacent ring elements 12, 32 and 32, 22, respectively, form a common bearing space for at least, optionally exactly, one of those pressure bodies 50.

Optionally, the bearing pocket bases 42 or the bearing pockets, respectively, are arranged and designed relative to one another in such a way that, during a load movement B_{L} of one of the ring elements 12, 22, 32, herein, for example, of the outer ring element 22, as a result of the acting torque M_{X}, the relative distance a of at least partial sections of the bearing pocket bases 42 pointing to one another measured in the radial direction R_{R} is reduced. This means that a pressure body arranged therein is compressed at least in the radial direction. This may happen in particular at locations where the pressure body rests against the bearing pocket bases. This process is represented in detail in FIGS. 7 through 9. It is discernible that, during a load movement B_{L} of the outer ring element 22 as a result of the torque M_{X} acting on it, the relative distances ai to as shown in the Figs. decrease as the outer ring element is moved further in the torque direction R_{M} or circumferential direction R_{U}, respectively. In principle, it is conceivable that the torque direction R_{M} corresponds to the circumferential direction R_{U}.

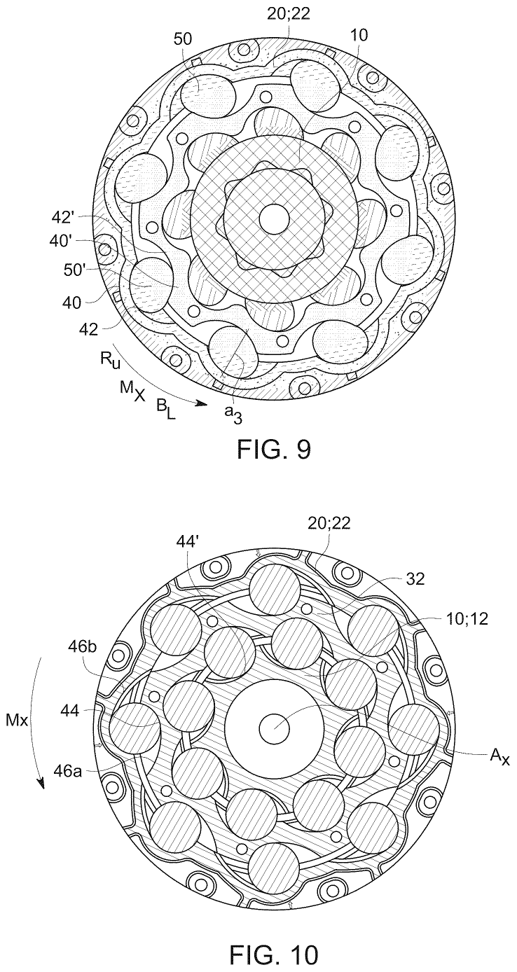

It is also discernible that, over the course of this movement of the outer ring element, a deformation of the pressure bodies 50 arranged between the outer ring element 22 and the middle ring element 32 takes place, which then leads to a load movement of the middle ring element 32 in the course of the load movement of the outer ring element (see FIGS. 8 and 9). This, too, then causes a deformation of the pressure bodies mounted further inwardly and finally a torque transmission to the first clutch element mounted inwardly herein or to the inner ring element (not represented), respectively.

It is also discernible in FIGS. 7 though 9 that during the load movement of the individual ring elements 12, 22, 32, a rolling movement of the pressure bodies 50 takes place within the bearing pockets.

As represented in FIG. 5A, in particular, the bearing pocket bases may be designed as bearings for the pressure bodies 50 in such a way that, upon application of the torque M_{X} and optionally the resulting load movement B_{L}, a circumferential force component F_{U} acts in the direction R_{M} of the torque M_{X}, and a radial force component F_{R} acts in the radial direction R_{R} on the pressure bodies 50 resting against them. Those two force components effect compression of the pressure body and, moreover, torque transmission acting in the torque direction. The response of the jaw coupling may optionally be defined by the resulting radial force component.

It is conceivable, wherein the individual components are again depicted in detail in FIG. 5A, that the elastically deformable inner pressure bodies 50i arranged in the inner bearing spaces 41i, optionally when in the non-deformed state, have a larger diameter Ø_{Di} than the elastically deformable outer pressure bodies 50a arranged in the outer bearing spaces 41a, and optionally have a diameter Ø_{Di} in the range of between 1.02 to 1.2 times larger, further optionally 1.05 to 1.15 times larger.

Herein, it is also represented that at least one bearing pocket base section 44 and/or at least one ramp base section 46, when viewed in the coupling cross-sectional plane perpendicular to the axis of rotation A_{X}, run in a circular-arc shape, wherein optionally, the radius R_{L} of the bearing pocket base section 44 is smaller than the radius R_{R} of the ramp base section 46.

It is conceivable that the radius R_{La} of at least one bearing pocket base section 44a of at least one outer bearing space 41a and/or the radius R_{Li} of at least one bearing pocket base section 44i of at least one inner bearing space 41i is substantially equal to the radius, optionally in the non-deformed state, of the pressure body 50a or 50i, respectively, mounted therein.

It is conceivable that at least one bearing pocket base section 44a of at least one outer bearing space 41a and at least one bearing pocket base section 44i of at least one inner bearing space 41i, when viewed in the coupling cross-sectional plane perpendicular to the axis of rotation A_{X}, each run in a circular-arc shape, wherein the radius R_{La} of the bearing pocket base section 44a of the outer bearing space 41a is smaller than the radius R_{Li} of the bearing pocket base section 44i of the inner bearing space 41i, and/or at least one ramp base section 46a of at least one outer bearing space 41a and at least one ramp base section 46i of at least one inner bearing space 41i, when viewed in the coupling cross-sectional plane perpendicular to the axis of rotation A_{X}, each run in a circular-arc shape, wherein the radius R_{Ra} of the ramp base section 46a of the outer bearing space 41a is smaller than the radius R_{Ri} of the ramp base section 46i of the inner bearing space 41i.

It is conceivable that one ramp base section 46a and one bearing pocket base section 44a of at least one outer bearing space 41a, in the coupling cross-sectional plane perpendicular to the axis of rotation A_{X}, each run in a circular-arc shape, wherein the radius R_{Ra} of the in particular inwardly pointing outer ramp base section 46ai is 1.5 to 4.0 times, optionally 2.0 to 3.5 times, larger than the radius R_{La} of the in particular inwardly pointing outer bearing pocket base section 44ai. It is also conceivable that one ramp base section 46i and one bearing pocket base section 44i of at least one inner bearing space 41i, in the coupling cross-sectional plane perpendicular to the axis of rotation A_{X}, each run in a circular-arc shape, wherein the radius R_{Ri} of the in particular inwardly pointing inner ramp base section 46ii is 1.0 to 3.0 times, optionally 1.5 to 2.5 times, larger than the radius R_{Li} of the in particular inwardly pointing inner bearing pocket base section 44ii.

It is possible that at least one bearing pocket base 42, when viewed in the coupling cross-sectional plane perpendicular to the axis of rotation Ax, is designed as a tray in which the pressure body mounted therein is guided in a stationary manner in the unloaded state of the coupling.

It is conceivable that at least one bearing pocket base 42, comprising a bearing pocket base section 44 and a ramp base section 46, when viewed in the coupling cross-sectional plane perpendicular to the axis of rotation A_{X}, runs in an arcuate manner and its running curve, with respect to a distance from the axis of rotation A_{X}, has a vertex P_{S} (see FIGS. 5B and 5C) with a maximum distance Aₘₐₓ from the axis of rotation A_{X}, wherein the vertex P_{S} is located in the bearing pocket base section 44.

The ramp base section 46 and the bearing pocket base section 44 merge into one another at a point P_{Ü}. It is conceivable that the merging point P_{Ü} corresponds to the vertex P_{S}.

It is conceivable (see FIG. 5C) that, when viewed in the coupling cross-sectional plane perpendicular to the axis of rotation A_{X}, a segmental arc center point P_{ML} of a bearing pocket base section 44, extending in a circular-arc shape, of at least one bearing pocket base 42 is located on a radial axis A_{R} through the axis of rotation A_{X}, and a segmental arc center point P_{MR} of a ramp base section 46, extending in a circular-arc shape, of the same bearing pocket base 42 is located on a parallel axis A_{RP} orthogonally offset from the radial axis by a value X.

FIG. 5B shows in detail the circular segments starting from the respective segmental arc center points P_{ML} and P_{MR}, the arcs of which, when viewed in the coupling cross-sectional plane perpendicular to the axis of rotation A_{X}, define the geometry of the bearing pocket base sections 44 and ramp base sections 46, respectively. When the bearing pocket base sections 44 and the ramp base sections 46 run straight in the axial direction, trays with a circular radius result geometrically.

It is conceivable that opposing ramp base sections 46 of bearing pockets 40 at adjacent ring elements 12, 32; 32, 22, with respect to the torque direction R_{M}, are designed as trailing ramp base sections 46b on the one ring element 12; 32 and as leading ramp base sections 46a on the adjacent ring element 32; 22. This is in particular represented in FIG. 5A.

In this embodiment, bearing spaces 41 for receiving at least one pressure body 50 are formed by two bearing pockets opposing one another, wherein those bearing pockets 40 are arranged on one of the adjacent ring elements 12, 22 or 32, 22, respectively. In this embodiment, the bearing pockets or their bearing pocket openings, respectively, point to one another. In this respect, at least one pressure body 50 is received or receivable, respectively, both in the bearing pocket 40 of the one ring element 12, 32 and in the bearing pocket 40 of the adjacent ring element 32, 22. It is also discernible (see FIG. 5A) that optionally, with the two bearing pockets opposing one another, when the torque M_{X} is not applied, lowest pocket points P_{T} of the bearing pockets may be located on a common radial axis A_{R}. It is also discernible that, if the torque M_{X} is not applied, the pressure bodies mounted in the bearing pockets cannot be deformed. Only upon applying the torque M_{X} and the resulting load movement B_{L}, this causes a displacement of the opposing bearing pockets relative to one another and thereby a deformation of the pressure bodies with resulting force coupling in the radial and circumferential directions and thus a torque transmission between the individual ring elements.

In this respect, the bearing pockets are defined in such a way that their depth changes along the circumferential direction R_{U} and, in particular, changes continuously. With those bearing pockets, the depth first increases in the circumferential direction and then decreases. It is optionally possible to determine the response or the load transmission capability, respectively, of the jaw coupling via the slope of the decrease or increase, respectively.

As represented in detail in FIGS. 5, 10 through 13, opposing ramp base sections 46 of bearing pockets 40 at adjacent ring elements 12, 32 or 32, 22, respectively, with respect to the torque direction R_{M}, may be designed as trailing ramp base sections 46a on the one ring element 12, 32 and as leading ramp base sections 46b on the adjacent ring element 32, 22. In the embodiments represented in FIGS. 1 and 10, the outer ring element 22 connected to the drive means 2, with respect to the torque direction R_{M}, has trailing ramp base sections 46b. The adjacent ring element 32 has ramp base sections 46 opposing them which are designed as leading ramp base sections 46a.

As represented by way of example in FIG. 5C, it is conceivable that, when viewed in the coupling cross-sectional plane perpendicular to the axis of rotation A_{X}, ramp base sections 46 opposing one another and forming a common bearing space have a substantially, in particular exactly, same length L_{RBA}. In this respect, the length L_{RBA} of the ramp base section is optionally, when viewed in the coupling cross-sectional plane perpendicular to the axis of rotation A_{X}, the length from the vertex Pₛ or merging point P_{Ü} (as represented in FIG. 5C) and the free end of the ramp base section, located at the outer or inner annular gap, respectively. In particular, all of the ramp base sections of the inner bearing spaces and/or of the outer bearing spaces may optionally be designed to be of a same length L_{RBA}.

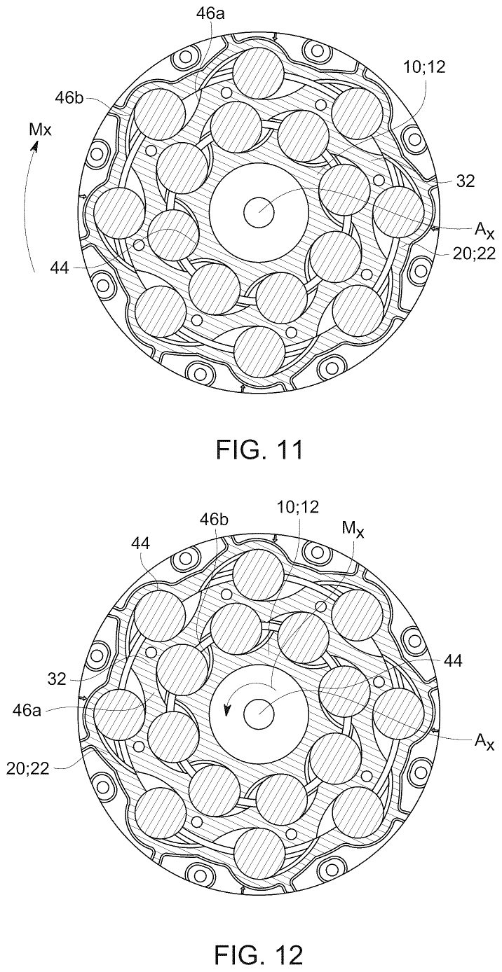

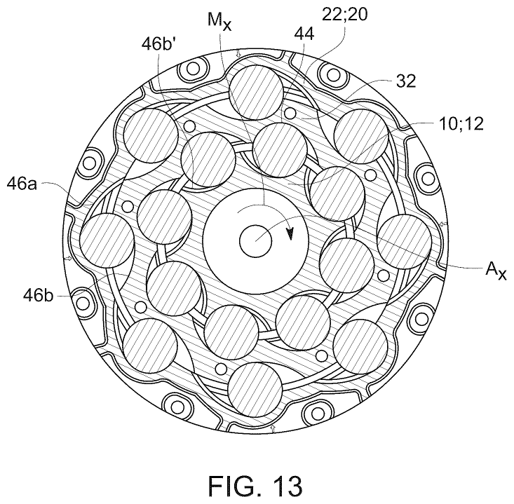

In FIGS. 10 through 13, embodiments differing herefrom are represented which differ both in the direction of the applied torques M_{X} and in the termination of the drive or output means, respectively. Thus, in FIGS. 10 and 11, the drive means is connected to the outer ring element 22 or clutch element 20, respectively, wherein it acts on the second clutch element 20 in a counterclockwise direction in FIG. 10 and in a clockwise direction in FIG. 11. In FIGS. 12 and 13, in contrast, the first clutch element and thus the inner ring element 12 is the element which is actively driven and connected to the drive means 2. Two different torque directions (in a counterclockwise direction in FIG. 12 and in a clockwise direction in FIG. 13) are represented herein as well. Depending on the driven component and the torque direction, the coupling has different orientations of the trailing or leading, respectively, ramp base sections.

In the embodiment represented herein, bearing pocket sections, and in particular the ramp base sections 46, formed on a ring element 12, 32 optionally run in the circumferential direction R_{U} in such a way that opposing in the radial direction R_{R}, no bearing pocket sections are formed on the adjacent ring element 32, 22, at least in a state in which no torque M_{X} acts (see, for example, FIG. 5A and FIGS. 10 through 13). It is conceivable that only after performing the load movement B_{L} (see FIGS. 7 through 9), the respective bearing pocket sections coincide and thus compress the intermediate pressure body.

1. A jaw coupling rotatable about an axis of rotation A_{X} for transmitting a torque M_{X}, acting about the axis of rotation A_{X}, from a drive means to an output means, comprising:
a first clutch element comprising an inner ring element extending concentrically with the axis of rotation A_{X} along a first circumference U₁; and
a second clutch element, rotatably mounted relative to the first clutch element, comprising an outer ring element extending concentrically with the axis of rotation A_{X} along an outer circumference U₂,
wherein the first clutch element is connected or connectable to the output means, and the second clutch element is connected or connectable to the drive means, or vice versa,
wherein the inner ring element and the outer ring element are arranged so as to point to one another in such a way that they form a common annular space between one another,
wherein at least one middle ring element is arranged in that common annular space so as to be rotatably mounted relative to the inner ring element and to the outer ring element in a circumferential direction R_{U},
wherein the inner ring element and an adjacent middle ring element of the at least one middle ring element form an inner annular gap, and the at least one middle ring element and an adjacent outer ring element form an outer annular gap,
wherein bearing pockets are formed on the inner ring element, the outer ring element, and the at least one middle ring element, with pocket openings thereof pointing into a respective inner annular gap or an respective outer annular gap,
wherein radially inwardly pointing outer bearing pockets of the bearing pockets are formed on the outer ring element,
wherein radially outwardly pointing outer bearing pockets of the bearing pockets and radially inwardly pointing inner bearing pockets of the bearing pockets are formed on the at least one middle ring element,
wherein radially outwardly pointing inner bearing pockets of the bearing pockets are formed on the inner ring element,
wherein inwardly and outwardly pointing outer bearing pockets pointing to one another form outer bearing spaces,
wherein inwardly and outwardly pointing inner bearing pockets pointing to one another form inner bearing spaces,
wherein elastically deformable outer pressure bodies are arranged in the outer bearing spaces, and elastically deformable inner pressure bodies are arranged in the inner bearing spaces,
wherein bearing pocket bases are formed in the bearing pockets, against which the elastically deformable outer pressure bodies and the elastically deformable inner pressure bodies rest and are force-coupled therewith such that the torque M_{X} is transmitted via the elastically deformable outer pressure bodies and the elastically deformable inner pressure bodies between the outer ring element and the inner ring element with the at least one middle ring element interposed,
wherein the elastically deformable outer pressure bodies and the elastically deformable inner pressure bodies form rollers with a diameter Ø_{D}, each rotatable about their rolling axis, coaxial with the axis of rotation A_{X}, and along the bearing pocket bases,
wherein the bearing pocket bases comprise a bearing pocket base section which points in a radial direction R_{R} to the respective inner annular gap or the respective outer annular gap, and which merges into a ramp base section trailing or leading in the circumferential direction R_{U} and likewise pointing in the radial direction R_{R} to the respective inner annular gap or the respective outer annular gap,
wherein a geometry of the ramp base section, when viewed in a coupling cross-sectional plane perpendicular to the axis of rotation A_{X}, differs from a geometry of the bearing pocket base section, and
wherein the elastically deformable inner pressure bodies arranged in the inner bearing spaces, when in a non-deformed state, have a larger diameter Ø_{Di} than the elastically deformable outer pressure bodies arranged in the outer bearing spaces.

2. The jaw coupling of claim 1,
wherein the elastically deformable inner pressure bodies arranged in the inner bearing spaces, when in the non-deformed state, have a diameter Ø_{Di} in a range between 1.02 to 1.2-times larger than the elastically deformable outer pressure bodies arranged in the outer bearing spaces.

3. The jaw coupling of claim 1,
wherein materials used in the elastically deformable outer pressure bodies and the elastically deformable inner pressure bodies have a substantially equal degree of hardness.

4. The jaw coupling of claim 1,
wherein the elastically deformable outer pressure bodies and the elastically deformable inner pressure bodies comprise a same material.

5. The jaw coupling of claim 1,
wherein the bearing pocket base section and/or the ramp base section, when viewed in the coupling cross-sectional plane perpendicular to the axis of rotation A_{X}, run in a circular-arc shape.

6. The jaw coupling of claim 1,
wherein a radius R_{La} of bearing pocket base section of the bearing pocket bases of the outer bearing spaces and/or a radius R_{Li} of another bearing pocket base section of the bearing pocket bases of the inner bearing spaces is substantially equal to a radius of the elastically deformable outer pressure bodies or the elastically deformable inner pressure bodies, respectively, mounted therein.

7. The jaw coupling of claim 1,
wherein a bearing pocket base section of the outer bearing spaces and another bearing pocket base section of the bearing pocket bases of inner bearing spaces, when viewed in the coupling cross-sectional plane perpendicular to the axis of rotation A_{X}, each run in a circular-arc shape, and a radius R_{La} of the bearing pocket base section of the outer bearing spaces is smaller than a radius R_{Li} of the another bearing pocket base section of the inner bearing spaces, and/or
wherein a ramp base section of at the outer bearing spaces and another ramp base section of the inner bearing spaces, when viewed in the coupling cross-sectional plane perpendicular to the axis of rotation A_{X}, each run in a circular-arc shape, and a radius R_{Ra} of the ramp base section of the outer bearing spaces is smaller than a radius R_{Ri} of the another ramp base section of the inner bearing spaces.

8. The jaw coupling of claim 1,
wherein a ramp base section and a bearing pocket base section of the bearing pocket bases of the outer bearing spaces, in the coupling cross-sectional plane perpendicular to the axis of rotation A_{X}, each run in a circular-arc shape, wherein a radius R_{Ra} of the ramp base section is 1.5 to 4.0-times larger than a radius R_{La} of the bearing pocket base section, and/or
wherein another ramp base section and another bearing pocket base section of the bearing pocket bases of the inner bearing spaces, in the coupling cross-sectional plane perpendicular to the axis of rotation A_{X}, each run in a circular-arc shape, wherein a radius R_{Ri} of the another ramp base section is 1.0 to 3.0-times larger than a radius R_{Li} of the another bearing pocket base section.

9. The jaw coupling of claim 1,
wherein at least one bearing pocket base, when viewed in the coupling cross-sectional plane perpendicular to the axis of rotation A_{X}, is configured as a tray in which a pressure body of the elastically deformable outer pressure bodies and the elastically deformable inner pressure bodies mounted therein is guided in a stationary manner in the an unloaded state of the jaw coupling.

10. The jaw coupling of claim 1,
wherein at least one bearing pocket base of the bearing pocket bases, comprising the bearing pocket base section and the ramp base section, when viewed in the coupling cross-sectional plane perpendicular to the axis of rotation A_{X}, runs in an arcuate manner,
wherein a running curve of the at least one bearing pocket base, with respect to a distance from the axis of rotation A_{X}, comprises a vertex P_{S} with a maximum distance Aₘₐₓ from the axis of rotation A_{X}, and
wherein the vertex P_{S} is located in the bearing pocket base section.

11. The jaw coupling of claim 1,
wherein, when viewed in the coupling cross-sectional plane perpendicular to the axis of rotation A_{X}, a segmental arc center point of the bearing pocket base section, extending in a circular-arc shape, of a bearing pocket base of the bearing pocket bases is located on a radial axis through the axis of rotation A_{X}, and
wherein a segmental arc center point of the ramp base section, extending in a circular-arc shape, of the bearing pocket base is located on a parallel axis orthogonally offset from the radial axis by a value X.

12. The jaw coupling of claim 1,
wherein opposing ramp base sections of the bearing pockets at adjacent ring elements of the inner ring element and the at least one middle ring element, with respect to a torque direction R_{M}, are configured as trailing ramp base sections on an inner ring element of the adjacent ring elements and as leading ramp base sections on a middle ring element of the adjacent ring elements, or
wherein another opposing ramp base sections of the bearing pockets at adjacent ring elements of the at least one middle ring element and the outer ring element, with respect to the torque direction R_{M}, are configured as trailing ramp base sections on a middle ring element of the adjacent ring elements and as leading ramp base sections on an outer ring element of the adjacent ring elements.

13. The jaw coupling of claim 1,
wherein ramp base sections at the inner ring element or the outer ring element connected or connectable to the drive means, with respect to a torque direction R_{M}, are configured as trailing ramp base sections.

14. The jaw coupling of claim 1,
wherein, when viewed in the coupling cross-sectional plane perpendicular to the axis of rotation A_{X}, ramp base sections opposing one another and forming a common bearing space have a same length L_{RBA}.

15. The jaw coupling of claim 5, wherein a radius of the bearing pocket base section is smaller than a radius of the ramp base section.

16. The jaw coupling of claim 6, wherein the radius R_{La} and/or the radius R_{Li} is substantially equal to the radius of the elastically deformable outer pressure bodies or the elastically deformable inner pressure bodies mounted therein in the non-deformed state.

17. The jaw coupling of claim 8, wherein a radius of an inwardly pointing outer ramp base section is 2.0 to 3.5-times larger than a radius of an inwardly pointing outer bearing pocket base section, and/or
wherein a radius of an inwardly pointing inner ramp base section is 1.5 to 2.5-times larger than a radius of an inwardly pointing inner bearing pocket base section.

18. The jaw coupling of claim 13, wherein opposing ramp base sections of a ring element of the at least one middle ring element adjacent to the inner ring element or the outer ring element are designed as leading ramp base sections.
